(19) United States
(12) Patent Application Publication
(10) Pub. No.: US 2026/0192626 A1
(43) Pub. Date: Jul. 9, 2026

(54) HEATING AND COOLING VAPOR INJECTION SYSTEM AND GAS-LIQUID SEPARATOR

(71) Applicant: HANON SYSTEMS, Daejeon (KR)

(72) Inventors: Yun Jin KIM, Daejeon (KR); Seong Hun KIM, Daejeon (KR); Hae Jun LEE, Daejeon (KR)

(21) Appl. No.: 19/134,518

(22) PCT Filed: Jan. 18, 2024
(86) PCT No.: PCT/KR2024/095035

§ 371 Date: May 30, 2025

(30) Foreign Application Priority Data
Feb. 10, 2023 (KR) 10-2023-0017694
Feb. 10, 2023 (KR) 10-2023-0017709

(51) Int. Cl. B60H 1/00; B01D 19/00

(52) U.S. Cl. CPC B60H 1/00007; B01D 19/0031; B01D 19/0063; B60H 1/00507

(57) ABSTRACT

A heating and cooling vapor injection system may comprise: a compressor that compresses and circulates refrigerant; a first refrigerant line through which the compressed refrigerant moves and in which a first expansion valve, a condenser, and an outdoor unit are installed; a gas-liquid separator into which the refrigerant that passes through the first refrigerant line flows and is separated into gaseous refrigerant and liquid refrigerant; a second refrigerant line through which the gaseous refrigerant discharged from the gas-liquid separator moves; and a third refrigerant line through which the liquid refrigerant discharged from the gas-liquid separator moves and in which a second expansion valve and an evaporator are installed. The second refrigerant line and the third refrigerant line are each branched off from the gas-liquid separator and connected to the compressor.

### TECHNICAL FIELD

The present invention relates to a heating and cooling vapor injection system and a gas-liquid separator, and more particularly, to a vapor injection system that implements a heating and cooling system using a single gas-liquid separator without a separate direction changing valve, and a gas-liquid separator capable of improving heating and cooling performance.

### BACKGROUND ART

Under the trend of environmentally friendly industrial development and development of energy sources that replace fossil fuels, the most notable areas in the automobile industry these days are electric vehicles and hybrid vehicles. These electric vehicles and hybrid vehicles are equipped with batteries to provide a driving force, and the batteries are used not only for driving, but also for heating and cooling.

In a vehicle that uses a battery to provide a driving force, using the battery as a heat source for heating and cooling means that a driving distance is reduced, and to overcome the above problem, a method of applying a heat pump system, which has been widely used in household heating and cooling devices, to a vehicle has been proposed.

The heat pump system uses a vapor injection module to enhance heating and cooling performance. The vapor injection module has a structure in which a gas-liquid separator is used in a refrigerant circulation system for heating and cooling to return gaseous refrigerant to a compressor and supply liquid refrigerant to an evaporator or chiller.

Referring to Japanese Unexamined Patent Publication No. 2021-160680 (Patent Document 1) which shows cooling and heating simultaneously performed using such a vapor injection module, two gas-liquid separators are connected to a front end and a rear end of an indoor unit to perform conversion to cooling and heating modes.

In order to implement a system that performs cooling and heating using two sets of vapor injection modules, a plurality of direction changing valves are required, which has a problem of complicating the system.

Also, referring to US Patent Publication No. 2020-0039323 (Patent Document 2) which shows cooling and heating simultaneously performed using a vapor injection system, a structure is disclosed that requires a complex refrigerant circulation line and a plurality of direction changing valves and accumulators to perform cooling and heating simultaneously. This structure has the problem of complicating the entire system.

Therefore, there is a need to solve the above problems.

### DETAILED DESCRIPTION OF INVENTION

### Technical Problem

An embodiment is directed to providing a vapor injection system capable of simultaneously performing cooling and heating using a single gas-liquid separator.

Further, an embodiment is also directed to providing a gas-liquid separator for a vehicle thermal management system that improves cooling and heating performance as well as simplifying the entire system by reducing the number of components.

The problems to be solved by the present invention are not limited to the problems mentioned above, and other problems that are not mentioned herein will be clearly understood by those skilled in the art from the description below.

### Technical Solution

One aspect of the present invention provides a heating and cooling vapor injection system including a compressor configured to compress and circulate a refrigerant, a first refrigerant line through which the compressed refrigerant moves and on which a first expansion valve, a condenser, and an outdoor unit are installed, a gas-liquid separator into which the refrigerant passing through the first refrigerant line is introduced and which separates the refrigerant into a gaseous refrigerant and a liquid refrigerant, a second refrigerant line through which the gaseous refrigerant discharged from the gas-liquid separator moves, and a third refrigerant line through which the liquid refrigerant discharged from the gas-liquid separator moves and on which a second expansion valve and an evaporator are installed, wherein each of the second refrigerant line and the third refrigerant line branches off at the gas-liquid separator and is connected to the compressor.

The heating and cooling vapor injection system may further include a fourth refrigerant line connected to the third refrigerant line in parallel to move the liquid refrigerant to the compressor and on which a third expansion valve and a chiller are installed, a first bypass line which branches off at the first expansion valve and is connected to the gas-liquid separator and through which the refrigerant moves, and a second bypass line of which one end is connected to the first refrigerant line and the other end is connected to the third refrigerant line between the condenser and the outdoor unit and through which the refrigerant moves.

On the third refrigerant line, the second expansion valve may be disposed on the inlet side of the evaporator, and a first branch part and a second branch part may be provided on the inlet side of the second expansion valve and the outlet side of the evaporator, respectively, and may be connected to the fourth refrigerant line, and on the fourth refrigerant line, the first branch part may be disposed on the inlet side of the third expansion valve, and the second branch par is disposed on the outlet side of the chiller.

On the first refrigerant line, a third branch part may be provided on the outlet side of the condenser, and the second bypass line may be connected to each of the third branch part and the second branch part.

The heating and cooling vapor injection system may further include an indoor unit disposed between the compressor and the first expansion valve on the first refrigerant line, and the indoor unit may be installed inside an air conditioning case together with the evaporator.

The heating and cooling vapor injection system may further include a fourth expansion valve disposed between the outdoor unit and the gas-liquid separator on the first refrigerant line, and the gas-liquid separator may constitute a vapor injection module together with the fourth expansion valve.

The gas-liquid separator may include a first port connected to the first refrigerant line, a second port connected to the first bypass line, a third port connected to the second refrigerant line, and a fourth port connected to the third refrigerant line, and according to air conditioning modes, the first port may be configured to selectively operate as an inlet through which the refrigerant is introduced or an outlet through which the refrigerant is discharged, the second port may be configured to operate as an inlet through which the refrigerant is introduced, and the third port and the fourth port may be configured to operate as outlets through which the refrigerant is discharged.

The outdoor unit may be formed so that an inlet and an outlet through which the refrigerant passes and moves are interchanged according to the air conditioning modes.

The refrigerant discharged from the compressor may move to the first refrigerant line or the first bypass line through opening or closing of the first expansion valve according to the air conditioning modes.

A 2-way valve may be disposed on the second bypass line.

In the case of a cooling mode, the first expansion valve may close the first bypass line and may implement a flow path connected to the first refrigerant line so that the refrigerant discharged from the compressor moves along the first refrigerant line and is introduced into the gas-liquid separator, and the gaseous refrigerant separated in the gas-liquid separator may move along the second refrigerant line and may be introduced into the compressor, and the liquid refrigerant separated from the gas-liquid separator may move along the third refrigerant line and may be introduced into the compressor.

In the case of a heating mode, the first expansion valve may close the first refrigerant line and may implement a flow path connected to the first bypass line so that the refrigerant discharged from the compressor moves along the first bypass line and is introduced into the gas-liquid separator, and the gaseous refrigerant that has passed through the gas-liquid separator may move along the second refrigerant line and may be introduced into the compressor, some of the liquid refrigerant that has passed through the gas-liquid separator may be branched off from the third refrigerant line and may move along the fourth refrigerant line to be introduced into the compressor, and the remaining liquid refrigerant may be branched off from the first refrigerant line and may move along the second bypass line to be introduced into the compressor.

Another aspect of the present invention provides a gas-liquid separator including a main body configured to accommodate a surplus liquid refrigerant therein, and a separation unit provided inside the main body, wherein the main body has a first port and a second port, through which a refrigerant in a two-phase state passes, in one side surface and the other side surface thereof, respectively, and a third port and a fourth port through which a gaseous refrigerant and a liquid refrigerant separated from the refrigerant in the two-phase state are discharged separately, in upper and lower surfaces thereof, respectively, and the separation unit prevents the liquid refrigerant from being introduced into the third port.

The separation unit may be configured to move along the main body in an up-down direction.

The separation unit may include a flat plate part that is horizontally disposed and has a shape corresponding to a cross-sectional shape of the main body, and a guide part that extends downward from the flat plate part.

The flat plate part may be positioned above a level of the surplus refrigerant.

The separation unit may further include a control part connected to the guide part to control a position of the flat plate part.

The control unit may include a power generator disposed outside the main body to generate a driving force to move the guide part in an up-down direction, or a buoyancy generator disposed inside the main body to generate a buoyancy to position an upper end of the guide part above the surplus refrigerant.

Based on a lower surface of the main body, the second port may be located to be higher than the first port is located, and the first port may be located at least at a level higher than or equal to a level of the surplus refrigerant.

The gas-liquid separator may further include a stopper provided inside of the main body and extending downward from an inner side of the upper surface, and the stopper may be configured to limit upward movement of the separation unit to prevent the third port from being blocked by the separation unit.

The stopper may be provided with a mesh structure and disposed to be connected to the third port inside the main body.

In a cooling mode, the first port may be opened and the second port may be blocked so that the refrigerant in the two-phase state is introduced into the main body through the first port, the separated liquid refrigerant is discharged through the fourth port with the surplus refrigerant, and the separated gaseous refrigerant is discharged through the third port.

In a heating mode, the first port and the second port may be opened so that the refrigerant in the two-phase state is introduced into the main body through the second port, some of the separated liquid refrigerant is discharged through the fourth port together with the surplus refrigerant, the remaining liquid refrigerant is discharged through the first port with the surplus refrigerant, and the separated gaseous refrigerant is discharged through the third port.

### Advantageous Effects

According to an embodiment of the present invention, a gas-liquid separator for a vehicle thermal management system that improves cooling/heating performance as well as simplifying the entire system by reducing the number of components can be provided.

Also, according to an embodiment, there is an effect of reducing costs and simplifying a structure of the system by minimizing a configuration for performing cooling and heating with a single gas-liquid separator.

The various advantageous and beneficial advantages and effects of the present invention are not limited to the above-described contents and will be more easily understood in the course of describing specific embodiments of the present invention.

### DESCRIPTION OF DRAWINGS

FIG. 1 is a schematic diagram showing a structure of a heating and cooling vapor injection system according to an embodiment of the present invention.

FIG. 2 is a schematic diagram showing a gas-liquid separator in FIG. 1.

FIG. 3 is a diagram showing a flow of refrigerant passing through an outdoor unit in FIG. 1.

FIG. 4 is a diagram showing the flow of refrigerant in a cooling mode in FIG. 1.

FIG. 5 is a diagram showing the flow of refrigerant in a heating mode in FIG. 1.

FIG. 6 is a schematic diagram showing a vehicle thermal management system according to an embodiment of the present invention.

FIG. 7 is a schematic diagram showing a gas-liquid separator in the vehicle thermal management system according to the embodiment of the present invention.

FIGS. 8A and 8B are schematic diagrams showing a stopper in the gas-liquid separator of FIG. 7.

FIG. 9 is a schematic diagram showing an operating state of the gas-liquid separator in the cooling mode.

FIG. 10 is a schematic diagram showing the operating state of the gas-liquid separator in the heating mode.

### MODES OF THE INVENTION

The present invention may have various modifications and embodiments, and specific embodiments are exemplified and described in the accompanying drawings. However, the specific embodiments are not intended to limit the present invention and should be understood to include all modifications, equivalents, or substitutes included in the spirit and technical scope of the present invention. Terms that include ordinal numbers, such as second, first, or the like, may be used to describe various components, but the components are not limited by the terms. The terms are used solely to distinguish one component from another. For example, without departing from the scope of the present invention, a second component could be named a first component, and similarly, the first component could also be named the second component. The term and/or includes any combination of multiple related/described items or any one of multiple/related described items.

When a component is “connected” or “linked” to another component, it should be understood that it may be directly connected or linked to the other component, but that there may also be other components therebetween. On the other hand, when it is said that a component is “directly connected” or “directly linked” to another component, it should be understood that there are no other components therebetween.

In the description of embodiments, when one component is described as being formed “on or under” another component, “on” or “under” includes not only a case in which the two components are in direct contact with each other, but also a case in which one or more other components are formed or disposed between the two components. Additionally, when expressed as “on or under,” it can include the meaning of not only the upward direction but also the downward direction based on one component.

The terminology used in this application is only used to describe specific embodiments and is not intended to limit the present invention. The singular expression includes the plural expression unless the context clearly indicates otherwise. In this application, it should be understood that terms such as “include” and “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Unless otherwise defined, all terms used herein, including technical or scientific terms, have the same meaning as commonly understood by a person of ordinary skill in the art to which this invention belongs. Terms defined in commonly used dictionaries should be interpreted as having a meaning consistent with their meaning in the context of the relevant art and will not be interpreted in an idealized or overly formal sense, unless expressly defined otherwise in this application.

Hereinafter, embodiments will be described in detail with reference to the attached drawings. Regardless of the drawing numbers, identical or corresponding components are given the same reference numerals, and redundant descriptions thereof will be omitted.

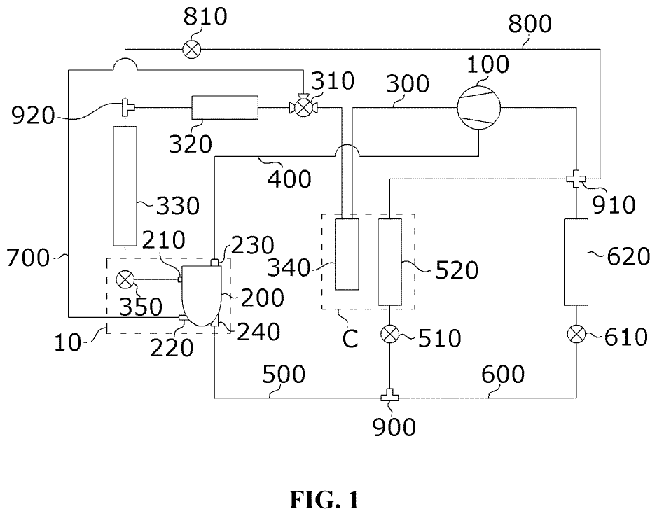

FIGS. 1 to 5 clearly illustrate only the main features to clearly understand the concept of the present invention, and as a result, various modifications of the drawings are expected, and the scope of the present invention need not be limited by specific shapes illustrated in the drawings.

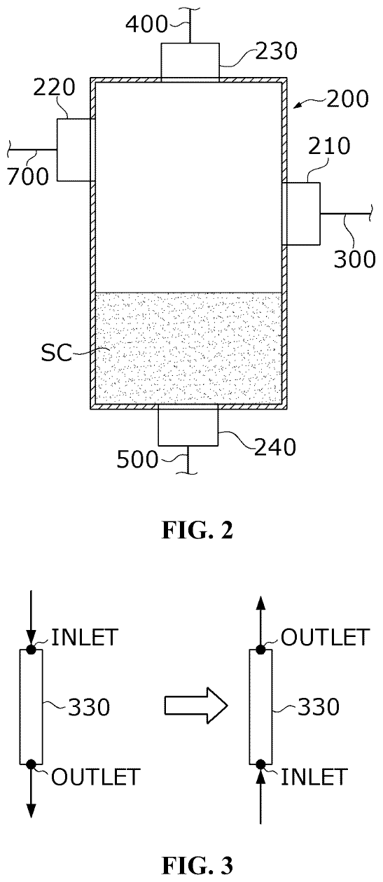

FIG. 1 is a schematic diagram showing a structure of a heating and cooling vapor injection system according to an embodiment of the present invention, FIG. 2 is a schematic diagram showing a gas-liquid separator in FIG. 1, and FIG. 3 is a diagram showing a flow of refrigerant passing through an outdoor unit in FIG. 1.

Referring to FIG. 1, the vapor injection system according to the embodiment of the present invention may include a compressor 100, a gas-liquid separator 200, a first refrigerant line 300, a second refrigerant line 400, a third refrigerant line 500, a fourth refrigerant line 600, a first bypass line 700, and a second bypass line 800.

The compressor 100 may compress and circulate a refrigerant. The compressor 100 is driven by power received from an engine (an internal combustion engine), a motor, etc., and may suction and compress the refrigerant, and then may discharge the refrigerant as a high temperature and high pressure gas to the first refrigerant line 300.

The refrigerant discharged from the compressor 100 moves along the first refrigerant line 300, and a first expansion valve 310, a condenser 320, and an outdoor unit 330 may be installed on the first refrigerant line 300.

In the embodiment, the first expansion valve 310, the condenser 320, and the outdoor unit 330 may be sequentially disposed in a direction in which the refrigerant moves along the first refrigerant line 300.

Additionally, an indoor unit 340 may be disposed between the compressor 100 and the first expansion valve 310 on the first refrigerant line 300.

The indoor unit 340 may be provided in an air conditioning case C disposed inside a vehicle. The indoor unit 340 may perform the role of heating the interior of the vehicle using heat generated from the refrigerant by exchanging heat between the refrigerant discharged from the compressor 100 and blown air.

The first expansion valve 310 is disposed on the inlet side of the condenser 320 and may perform a function of controlling a movement direction, expansion, and flow rate of the refrigerant. In the embodiment, a 3/2-way expansion valve may be used as the first expansion valve 310.

The condenser 320 may condense the refrigerant compressed in the compressor 100.

The condenser 320 may be either an air-cooled condenser or a water-cooled condenser. When a water-cooled condenser is used, condensation may occur through performing heat exchange between the refrigerant and a coolant moving through a vehicle's coolant circulation line.

The outdoor unit 330 is installed in front of a vehicle engine room as an air-cooled heat exchanger together with a radiator and may be disposed on a straight line in a flow direction of the blown air. Additionally, in the outdoor unit 330, a low temperature coolant discharged from the radiator may be heat-exchanged with an air.

Such an outdoor unit 330 may perform different roles according to air conditioning modes.

In the embodiment, the outdoor unit 330 may perform the same role as the condenser 320 in a cooling mode. In addition, the outdoor unit 330 may perform the role of an evaporator in contrast to the condenser 320 in a heating mode. To this end, the outdoor unit 330 may be formed so that an inlet and an outlet through which the refrigerant passes are interchanged according to the air conditioning modes. Thus, it is possible to design the outdoor unit 330 so that an amount of pressure drop of the refrigerant is minimized for each of the air conditioning modes.

The refrigerant that has passed through the outdoor unit 330 may move along the first refrigerant line 300 and may be introduced into the gas-liquid separator 200.

As shown in the drawing, a fourth expansion valve 350 may be disposed between the outdoor unit 330 and the gas-liquid separator 200 on the first refrigerant line 300. The fourth expansion valve 350 may perform the function of controlling the movement direction, expansion, and flow rate of the refrigerant.

The first bypass line 700 branches off at the first expansion valve 310 and is connected to the gas-liquid separator 200, and the refrigerant discharged from the compressor 100 may move therethrough and may be introduced into the gas-liquid separator 200.

In accordance with the air conditioning modes, the refrigerant discharged from the compressor 100 may move along the first refrigerant line 300 or the first bypass line 700 through opening or closing of the first expansion valve 310 and may be introduced into the gas-liquid separator 200.

The gas-liquid separator 200 may separate the incoming refrigerant into gaseous refrigerant and liquid refrigerant and may separately discharge the gaseous refrigerant and the liquid refrigerant. Then, the gaseous refrigerant in the separated refrigerant may be reintroduced into the compressor 100.

The gas-liquid separator 200 may be provided with a plurality of ports through which the refrigerant is introduced and discharged. In the embodiment, the gas-liquid separator 200 may have a first port 210 connected to the first refrigerant line 300, a second port 220 connected to the first bypass line 700, a third port 230 connected to the second refrigerant line 400, and a fourth port 240 connected to the third refrigerant line 500.

As shown in the drawing, the first port 210 and the second port 220 may be provided on a side surface of the gas-liquid separator 200, the third port 230 may be provided on an upper surface of the gas-liquid separator 200, and the fourth port 240 may be provided on a lower surface of the gas-liquid separator 200. In this case, the second port 220 may be located above the first port 210.

The first port 210 may be selectively operated as an inlet through which the refrigerant is introduced or an outlet through which the refrigerant discharged according to the air conditioning modes. Additionally, regardless of the air conditioning modes, the second port 220 may be operated as an inlet through which the refrigerant is introduced, and the third port 230 and the fourth port 240 may be operated as outlets through which the refrigerant is discharged.

The gas-liquid separator 200 may be configured to separate the refrigerant into gaseous and liquid phases before the refrigerant is circulated and introduced into the compressor 100, and at the same time, to receive and store a certain amount of surplus liquid refrigerant SC therein. Thus, only the gaseous refrigerant in the refrigerant flowing along the refrigerant lines in the system is supplied to the compressor 100, the surplus refrigerant SC is stored, and thus the gas-liquid separator 200 may perform a function similar to that of an accumulator.

This gas-liquid separator 200 may constitute a vapor injection module 10 together with the fourth expansion valve 350.

The second refrigerant line 400 is connected to the third port 230 of the gas-liquid separator 200, and the gaseous refrigerant discharged from the gas-liquid separator 200 may be moved therethrough and may be reintroduced into the compressor 100.

The third refrigerant line 500 is connected to the fourth port 240 of the gas-liquid separator 200, and the liquid refrigerant discharged from the gas-liquid separator 200 moves along the third refrigerant line 500, and a second expansion valve 510 and an evaporator 520 may be installed on the third refrigerant line 500.

In the third refrigerant line 500, the second expansion valve 510 is disposed on the inlet side of the evaporator 520, and a first branch part 900 and a second branch part 910 may be provided on the inlet side of the second expansion valve 510 and the outlet side of the evaporator 520, respectively.

The second expansion valve 510 may perform functions of refrigerant expansion, flow rate control, and opening/closing.

The evaporator 520 may be disposed inside an air conditioning case C together with the indoor unit 340 to perform cooling and heating of the interior of the vehicle. The evaporator 520 is supplied with low temperature and low pressure refrigerant discharged from the second expansion valve 510, and while air flowing inside the air conditioning case C through a blower passes the evaporator 520, the air is heat-exchanged with the low temperature and low pressure refrigerant inside the evaporator 520, is changed into cold air, and then can be discharged into the interior of the vehicle.

In this way, each of the second refrigerant line 400 and the third refrigerant line 500 branches off at the gas-liquid separator 200, is connected to the compressor 100, and is formed so that the refrigerant circulates and is reintroduced into the compressor 100.

The fourth refrigerant line 600 is connected to the third refrigerant line 500 in parallel and may move the liquid refrigerant passing through the fourth refrigerant line 600 to the compressor 100. A third expansion valve 610 and a chiller 620 may be installed on the fourth refrigerant line 600.

In the fourth refrigerant line 600, the third expansion valve 610 may be disposed on the inlet side of the chiller 620. The third expansion valve 610 may perform the functions of refrigerant expansion, flow rate control, and opening/closing.

The chiller 620 is supplied with the low temperature and low pressure refrigerant that has passed through the third expansion valve 610, and the low temperature and low pressure refrigerant may be heat-exchanged with the coolant moving through a coolant circulation line in a vehicle air conditioning system. The coolant cooled while passing through the chiller 620 may cool heat-generating components such as a vehicle's battery.

The first branch part 900 may be disposed on the inlet side of the third expansion valve 610 on the fourth refrigerant line 600, and the second branch part 910 may be disposed on the outlet side of the chiller 620. Thus, the fourth refrigerant line 600 may be connected to the third refrigerant line 500 through the first branch part 900 and the second branch part 910.

The second bypass line 800 may have one side connected to the first refrigerant line 300 and the other side connected to the third refrigerant line 500 between the condenser 320 and the outdoor unit 330.

Specifically, a third branch part 920 is provided on the outlet side of the condenser 320 on the first refrigerant line 300, and the second bypass line 800 may be connected to each of the third branch part 920 and the second branch part 910.

When the first port 210 of the gas-liquid separator 200 operates as an outlet through which the refrigerant is discharged according to the air conditioning modes, the liquid refrigerant separated in the gas-liquid separator 200 may move to the second bypass line 800 and may be reintroduced into the compressor 100.

A 2-way valve 810 may be disposed on this second bypass line 800.

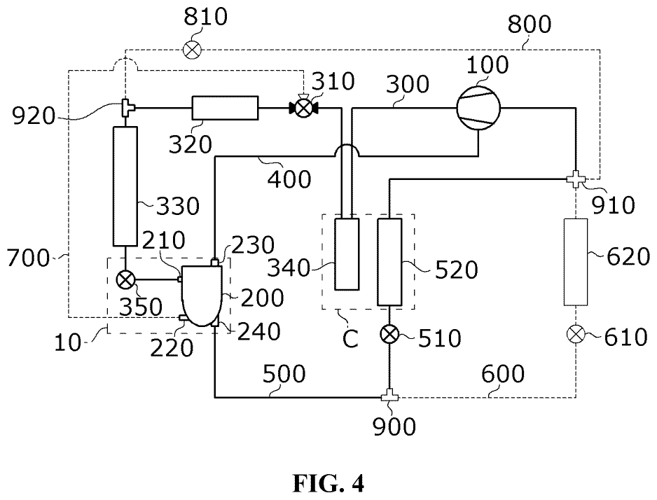

FIG. 4 schematically shows a flow of the refrigerant in the cooling mode.

Referring to the drawing, the compressor 100 operates, and a high temperature and high pressure refrigerant is discharged from the compressor 100. The refrigerant discharged from the compressor 100 moves along the first refrigerant line 300.

In the cooling mode, the first expansion valve 310 closes the first bypass line 700 and implements a flow path connected to the first refrigerant line 300. Thus, the refrigerant discharged from the compressor 100 moves along the first refrigerant line 300 through the indoor unit 340 and the first expansion valve 310, condenses while passing through the condenser 320, and then moves to the gas-liquid separator 200 through the outdoor unit 330. At this time, the refrigerant is primarily expanded and depressurized while passing through the fourth expansion valve 350 and then introduced into the gas-liquid separator 200 through the first port 210.

The liquid refrigerant separated in the gas-liquid separator 200 may be discharged to the fourth port 240 and may move along the third refrigerant line 500, and the gaseous refrigerant separated in the gas-liquid separator 200 may be discharged through the third port 230 and may move along the second refrigerant line 400 to be reintroduced into the compressor 100. In this case, the second port 220 is maintained in a closed state.

In a state in which the second expansion valve 510 is opened and the third expansion valve 610 is closed, the liquid refrigerant moving along the third refrigerant line 500 is secondarily expanded and depressurized while passing through the second expansion valve 510. Then, as the expanded and depressurized refrigerant passes through the evaporator 520, the refrigerant is heat-exchanged with the air blown by the blower (not shown) of the air conditioning case C, and the air is cooled while the refrigerant is evaporated, and the cooled air is supplied to the interior of the vehicle, thereby cooling the interior of the vehicle.

The refrigerant evaporated in the evaporator 520 may move along the third refrigerant line 500 and may be reintroduced into the compressor 100 to be circulated.

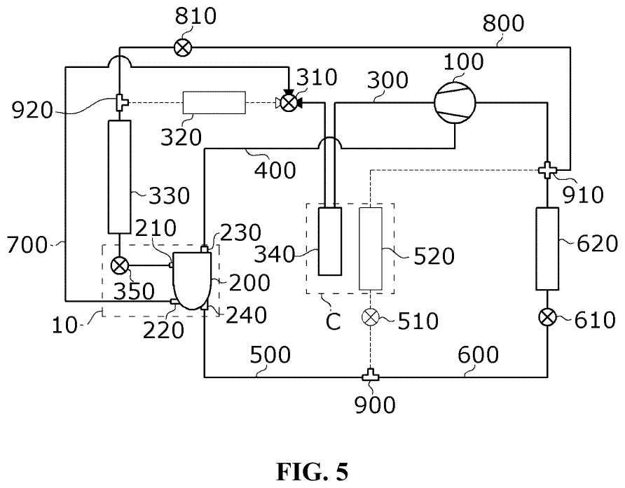

FIG. 5 schematically shows the flow of the refrigerant in the heating mode.

Referring to the drawing, the compressor 100 is operated and the high temperature and high pressure refrigerant is discharged from the compressor 100. The refrigerant discharged from the compressor 100 moves along the first refrigerant line 300.

In the heating mode, the first expansion valve 310 closes the first refrigerant line 300 and implements a flow path connected to the first bypass line 700. Thus, the refrigerant discharged from the compressor 100 moves along the first bypass line 700 through the indoor unit 340 and the first expansion valve 310 and moves to the gas-liquid separator 200. At this time, the refrigerant is primarily expanded and depressurized while passing through the first expansion valve 310 and is then introduced into the gas-liquid separator 200 through the second port 220.

Some of the liquid refrigerant separated in the gas-liquid separator 200 is discharged through the fourth port 240 and moves along the third refrigerant line 500, and the gaseous refrigerant separated in the gas-liquid separator 200 is discharged through the third port 230, moves along the second refrigerant line 400, and may be reintroduced into the compressor 100.

In a state in which the second expansion valve 510 is closed and the third expansion valve 610 is opened, the liquid refrigerant moving along the third refrigerant line 500 moves from the first branch part 900 to the fourth refrigerant line 600, is secondarily expanded and decompressed while passing through the third expansion valve 610, and then moves.

Then, the expanded and depressurized refrigerant may be heat-exchanged with the coolant while passing through the chiller 620 and the coolant may be cooled while the refrigerant is evaporated. Then, the refrigerant evaporated in the chiller 620 may be reintroduced into the compressor 100 through the second branch part 910 and may be circulated.

Meanwhile, the remaining liquid refrigerant separated in the gas-liquid separator 200 is discharged through the first port 210, moves along the first refrigerant line 300, and is secondarily expanded and depressurized while passing through the fourth expansion valve 350.

Then, the refrigerant may pass through the outdoor unit 330, may move from the third branch part 920 to the second bypass line 800, may be reintroduced into the compressor 100 through the second branch part 910, and then may be circulated.

As described above, the heating and cooling vapor injection system according to the embodiment of the present invention is formed so that a gas phase and a liquid phase are separated from the refrigerant through the gas-liquid separator 200 before the refrigerant is circulated through the refrigerant line and reintroduced into the compressor 100 and at the same time, surplus refrigerant is stored therein, and thus may perform a function similar to that of an accumulator disposed on the inlet side of the compressor in a conventional system. Thus, according to the embodiment, the accumulator is omitted, and thus there is an effect of simplifying the configuration of the entire system and reducing cost due to a reduction in the number of components such as a direction changing valve.

In addition, when the cooling/heating vapor injection function is implemented using one gas-liquid separator 200, the flow path of the refrigerant line can be simplified throughout the entire system, and in particular, by switching the inlet and the outlet of the outdoor unit 330 in reverse according to the air conditioning modes, the amount of pressure drop of the refrigerant may be minimized, and the cooling/heating performance may be improved.

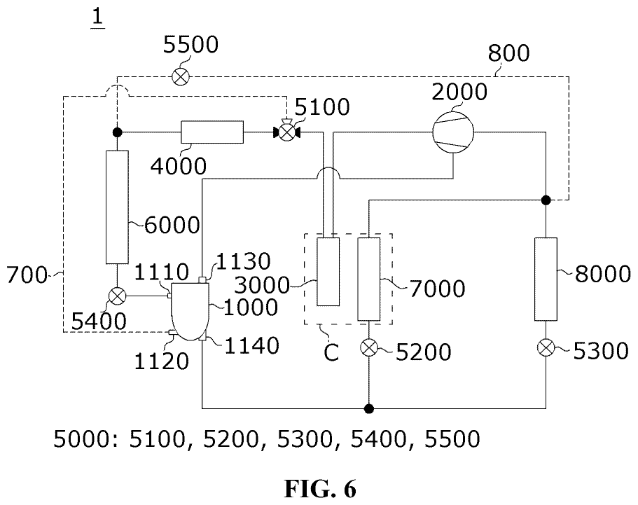

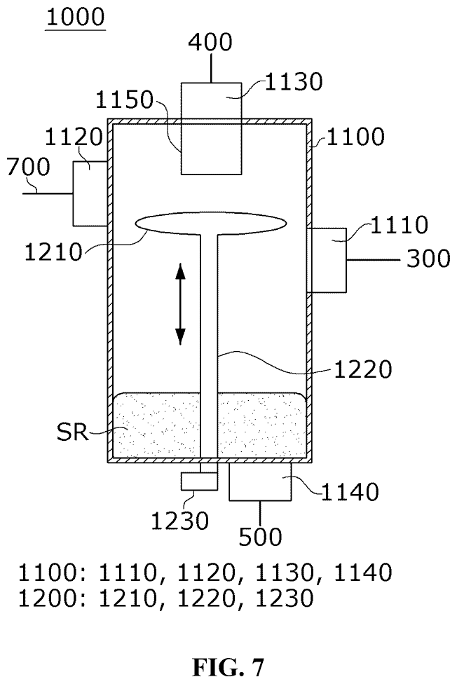

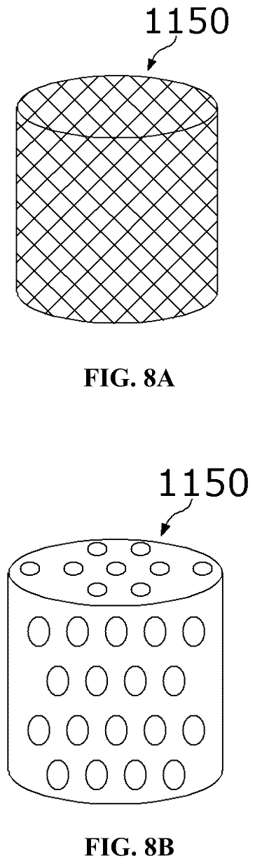

Hereinafter, the gas-liquid separator according to the embodiment of the present invention is described. FIG. 6 is a schematic diagram showing a vehicle thermal management system according to an embodiment of the present invention, FIG. 7 is a schematic diagram showing a gas-liquid separator in the vehicle thermal management system according to the embodiment of the present invention, and FIGS. 8A and 8B are schematic diagrams showing a stopper in the gas-liquid separator of FIG. 7.

In an embodiment of the present invention, a gas-liquid separator 1000 may be configured to separate a gaseous refrigerant and a liquid refrigerant from a refrigerant in a two-phase state during cooling and heating of a vehicle.

FIG. 6 schematically shows the configuration of a vehicle thermal management system 1 in which the gas-liquid separator 1000 according to the embodiment of the present invention is installed.

Referring to the drawings, the vehicle thermal management system 1 according to the embodiment of the present invention may include a compressor 2000, an indoor unit 3000, a condenser 4000, an expansion unit 5000, the gas-liquid separator 1000, an outdoor unit 6000, an evaporator 7000, and a chiller 8000. Additionally, the expansion unit 5000 may include first to fourth expansion valves 5100, 5200, 5300, and 5400.

The compressor 2000 is driven by power received from an engine (an internal combustion engine), motor, etc., suctions and compresses a refrigerant, and then discharges the refrigerant to the condenser 4000 as a high temperature and high pressure gas.

The indoor unit 3000 may perform indoor heating by exchanging heat with air conditioning air using heat of the refrigerant introduced from the compressor 2000. The indoor unit 3000 may be disposed inside the air conditioning case C of the vehicle together with the evaporator 7000 to be described below to heat the interior of the vehicle.

In one embodiment, the indoor unit 3000 may use a condenser as a heat exchanger for indoor heating.

The refrigerant moving through the indoor unit 3000 is heat-exchanged with the air, and the heat-exchanged air may be introduced into the interior to perform the indoor heating. Additionally, the refrigerant of the indoor unit 3000 may be heat-exchanged with a coolant, and the heat-exchanged coolant may be heat-exchanged with the air for indoor heating. Such an indoor unit 3000 may be either an air-cooled indoor unit or a water-cooled indoor unit.

In one embodiment, the indoor unit 3000 may further include a water-cooled condenser that performs heat exchange between the discharged refrigerant and the coolant. The water-cooled condenser included in the indoor unit 3000 performs heat exchange between the refrigerant and the coolant moving through a coolant line, and the heat-exchanged coolant may perform the indoor heating.

The condenser 4000 functions as a condenser in both the cooling mode and the heating mode. The condenser 4000 may condense compressed refrigerant. The refrigerant condensed in the condenser 4000 moves along a refrigerant line and is supplied to the outdoor unit 6000. In one embodiment, the condenser 4000 may be a water-cooled condenser.

The first expansion valve 5100 may be installed on the first refrigerant line 300 that connects the condenser 4000 and the indoor unit 3000.

The first expansion valve 5100 may perform functions of controlling the movement direction, expansion, and flow rate of the introduced refrigerant. In the embodiment, a 3/2-way expansion valve may be used as the first expansion valve 5100.

The first expansion valve 5100 may be connected to the gas-liquid separator 1000, which will be described below, through the first bypass line 700.

The outdoor unit 6000 is installed in front of a vehicle engine room as an air-cooled heat exchanger together with a radiator and may be disposed in a straight line in a direction of air flow blown from a blower fan. Additionally, the outdoor unit 6000 may perform heat exchange between a low temperature coolant discharged from the radiator and an air.

The outdoor unit 6000 may perform different roles according to the air conditioning modes. In the cooling mode, the outdoor unit 6000 may perform the same condenser role as the water-cooled condenser 4000. Additionally, in the heating mode, the outdoor unit 6000 may perform the role of an evaporator in contrast to the water-cooled condenser 4000.

The fourth expansion valve 5400 is installed on the first refrigerant line 300 that connects the outdoor unit 6000 and the gas-liquid separator 1000 and may perform the functions of controlling the movement direction, expansion, and flow rate of the introduced refrigerant.

The gas-liquid separator 1000 separates the refrigerant in the two-phase state that has passed through the fourth expansion valve 5400 into the gaseous refrigerant and the liquid refrigerant and may discharge the gaseous refrigerant and the liquid refrigerant separately from each other.

The separated gaseous refrigerant may be transferred to the compressor 2000 along the second refrigerant line 400, and the separated liquid refrigerant may be branched off and transferred to the evaporator 7000 or the chiller 8000 along the third refrigerant line 500.

The second expansion valve 5200 is disposed on the inlet side of the evaporator 7000 and may perform the functions of refrigerant expansion, flow control, and opening/closing.

The evaporator 7000 is installed inside the air conditioning case C and is disposed on the third refrigerant line 500, the low temperature and low pressure refrigerant discharged from the second expansion valve 5200 is supplied thereto and, as air flowing through the inside of the air conditioning case C through the blower passes the evaporator, the air is heat-exchanged with the low temperature and low pressure refrigerant inside the evaporator 7000, is changed into cold air, and then discharged into the interior of the vehicle to cool the interior. That is, the evaporator 7000 performs the role of an evaporator on the third refrigerant line 500.

The third expansion valve 5300 is connected to the second expansion valve 5200 in parallel through the fourth refrigerant line 600 and may perform the functions of refrigerant expansion, flow rate control, and opening/closing.

The chiller 8000 is supplied with the low temperature and low pressure refrigerant discharged from the third expansion valve 5300, and the low temperature and low pressure refrigerant may be heat-exchanged with the coolant moving through the coolant circulation line. Additionally, the coolant that has been heat-exchanged in the chiller 8000 may circulate through the coolant circulation line and may be heat-exchanged with a high-temperature battery.

The chiller 8000 may be connected to the third refrigerant line 500 that connects the evaporator 7000 and the compressor 2000 via the fourth refrigerant line 600. In addition, the third refrigerant line 500 that connects the evaporator 7000 and the compressor 2000 may be connected, through the second bypass line 800, to the first refrigerant line 300 that connects the condenser 4000 and the outdoor unit 6000. A 2-way valve 5500 may be installed on the second bypass line 800.

The first to fourth expansion valves 5100, 5200, 5300, and 5400 shown in the embodiment of the present invention may perform the functions of expansion, distribution, and blocking according to each mode. That is, each of the expansion valves may perform the functions of expanding the refrigerant, passing the refrigerant without expansion, or blocking the refrigerant. FIG. 7 schematically shows the gas-liquid separator 1000 according to the embodiment of the present invention.

Referring to the drawing, the gas-liquid separator 1000 according to the embodiment of the present invention may include a main body 1100 and a separation unit 1200.

The main body 1100 has an internal space and may have an overall sealed box-shaped structure. In an embodiment, the main body 1100 may have a cylindrical structure.

The main body 1100 may accommodate and store a certain amount of a liquid surplus refrigerant SR therein. Thus, only the gaseous refrigerant in the refrigerant flowing along the refrigerant line of the vehicle thermal management system 1 is supplied to the compressor 2000, and the surplus refrigerant SR is stored so that the gas-liquid separator 1000 may perform the same role as an accumulator.

The main body 1100 may have a first opening 1110 and a second opening 1120, through which the refrigerant in the two-phase state passes, in one side surface and the other side surface, respectively.

In accordance with the air conditioning modes, the refrigerant R in the two-phase state may be introduced into the main body 1100 through either the first port 1110 or the second port 1120. Additionally, the liquid refrigerant R2 separated from the introduced refrigerant R in the two-phase state may be discharged outside the main body 1100 through one of the first port 1110 and the second port 1120. Thus, the first port 1110 and the second port 1120 may perform the role of an inlet through which the refrigerant R is introduced and an outlet through which the refrigerant R is discharged.

In an embodiment, the second port 1120 may be located to be higher than the first port 1110 with respect to a lower surface of the main body 1100. In addition, the first port 1110 may be located at least at a level higher than or equal to a level of the surplus refrigerant SR.

In the vehicle thermal management system 1 according to the embodiment of the present invention, the first port 1110 may be connected to the outdoor unit 6000 through the first refrigerant line 300. Then, the second port 1120 may be connected, through the first bypass line 700, to the expansion unit 50 installed on the first refrigerant line 300 that connects the indoor unit 3000 and the condenser 4000. In this case, the expansion unit 5000 may be the first expansion valve 5100.

The refrigerant R in the two-phase state that is introduced into the main body 1100 may be separated into a gaseous refrigerant R1 and a liquid refrigerant R2 inside the main body 1100.

The main body 1100 may have a third port 1130 and a fourth port 1140 on an upper surface and a lower surface thereof, respectively, through which the gaseous refrigerant R1 and the liquid refrigerant R2 separated from the refrigerant R in the two-phase state are discharged separately from each other.

In the vehicle thermal management system 1 according to the embodiment of the present invention, the third port 1130 may be connected to the compressor 2000 through the second refrigerant line 400. Additionally, the fourth port 1140 may be connected to the evaporator 7000 and the chiller 8000 through the third refrigerant line 500.

Meanwhile, the inside of the main body 1100 may be provided with a stopper 1150 that extends from the inner side of the upper surface toward the lower side.

This stopper 1150 is configured to limit upward movement of the separation unit 1200 to be described below, thereby preventing the third port 1130 from being blocked by the separation unit 1200.

As shown in FIG. 8, the stopper 1150 may be provided as a mesh structure. Additionally, the stopper 1150 may be disposed to be connected to the third port 1130 inside the main body 1100. Therefore, the gaseous refrigerant R1 is introduced into the third port 1130 through the stopper 1150 and then discharged to the outside.

The separation unit 1200 may be movably provided in an up-down direction within the main body 1100.

This separation unit 1200 may be configured to prevent the liquid refrigerant R2 from being introduced into the third port 1130.

As shown in the drawing, the separation unit 1200 may include a flat plate part 1210 and a guide part 1220. In addition, the separation unit 1200 may further include a control part 1230.

The flat plate part 1210 and the guide part 1220 may be formed integrally. That is, the flat plate part 1210 and the guide part 1220 may have an integrally connected structure. The control part 1230 may be selectively connected to the guide part 1220.

The flat plate part 1210 may have a shape corresponding to a cross-sectional shape of the main body 1100 and may be disposed horizontally within the main body 1100. The flat plate part 1210 may be disposed to be positioned above the level of the surplus refrigerant SR.

In an embodiment, the flat plate part 1210 may be formed with a porous structure. Thus, the gaseous refrigerant R1 may pass through the flat plate part 1210, but the liquid refrigerant R2 may not pass through the flat plate part 1210.

The guide part 1220 has a structure of a roughly long rod-shaped structure and may be provided to extend downward from a lower surface of the flat plate part 1210.

The control part 1230 may be connected to the guide part 1220 and may adjust a position of the flat plate part 1210 by moving the guide part 1220.

In an embodiment, the control part 1230 may include a power generator that is disposed outside the main body 1100 and generates a driving force to move the guide part 1220 in the up-down direction. As the power generator, an actuator may be used, for example, but the present invention is not limited thereto.

Additionally, the control part 1230 may include a buoyancy generator that is disposed inside the main body 1100 and generates a buoyancy to position an upper end of the guide part 1220 above the surplus refrigerant SR.

In this way, an arrangement position of the flat plate part 1210 may be adjusted so that the flat plate part 1210 is always positioned above the level of the surplus refrigerant SR by the control part 1230.

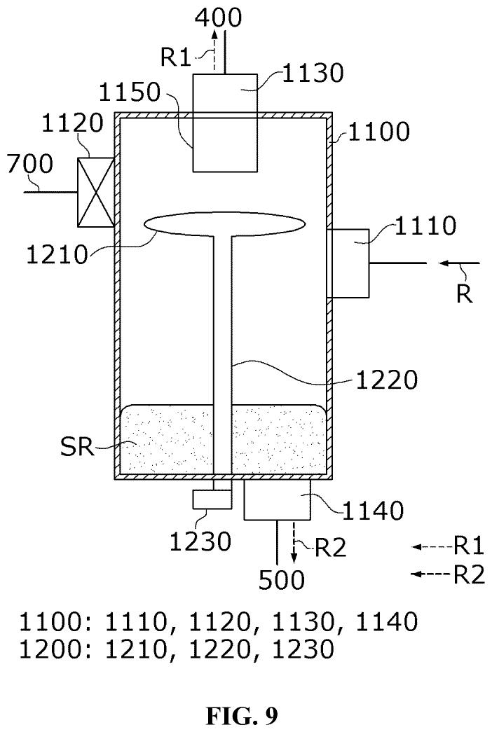

FIG. 9 schematically shows an operating state of the gas-liquid separator 1000 in the cooling mode.

Referring to the drawing, in the cooling mode, the first port 1110 may be opened and the second port 1120 may be blocked. The second port 1120 is blocked by closing the first expansion valve 5100 connected through the first bypass line 700 and thus preventing the refrigerant R from flowing along the first bypass line 700.

In this way, in a state in which the first port 1110 is opened and the second port 1120 is blocked, the refrigerant R in the two-phase state is introduced into the main body 1100 through the first port 1110 and is separated into the gaseous refrigerant R1 and the liquid refrigerant R2.

The separated gaseous refrigerant R1 is discharged through the third port 1130 provided at an upper portion of the main body 1100 and transferred to the compressor 2000.

In addition, the separated liquid refrigerant R2 is discharged through the fourth port 1140 provided at a lower portion of the main body 1100 together with the surplus refrigerant SR and is transferred to the evaporator 7000 along the refrigerant line. Then, the separated liquid refrigerant R2 is transferred to the compressor 2000 through the evaporator 7000.

In the cooling mode, since an amount of circulating refrigerant R is relatively greater than in the heating mode, the level of surplus refrigerant SR stored inside the main body 1100 is maintained in a low state.

The separation unit 1200 is disposed so that the flat plate part 1210 is positioned above the first port 1110, thereby preventing the liquid refrigerant R2 in the refrigerant R introduced into the main body 1100 through the first port 1110 from being introduced into the third port 1130 located at the upper portion of the main body 1100.

Each of the gaseous refrigerant R1 and the liquid refrigerant R2 discharged from the main body 1100 may be transferred to the compressor 2000 and then reintroduced into the first port 1110 along the first refrigerant line 300, and may be circulated.

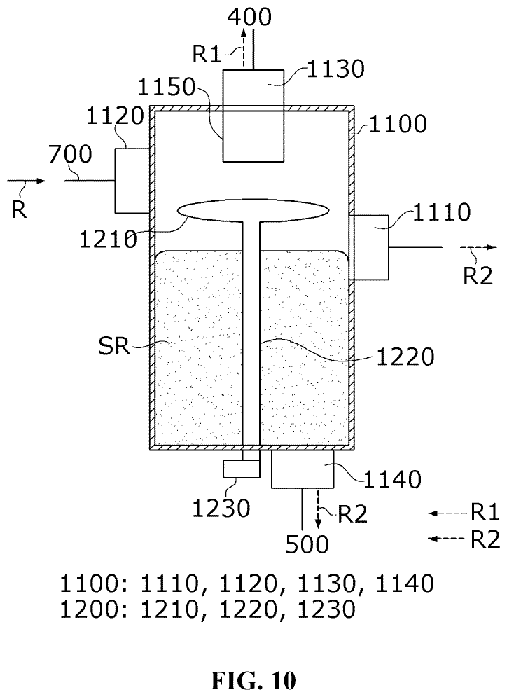

FIG. 10 schematically shows the operating state of the gas-liquid separator 1000 in the heating mode.

Referring to the drawing, in the heating mode, each of the first port 1110 and the second port 1120 may be opened.

In this way, in a state in which the first port 1110 and the second port 1120 are opened, the refrigerant R in the two-phase state is introduced into the main body 1100 through the second port 1120 and is separated into the gaseous refrigerant R1 and the liquid refrigerant R2.

The separated gaseous refrigerant R1 is discharged through the third port 1130 provided at the upper portion of the main body 1100 and is then transferred to the compressor 2000.

In addition, the separated liquid refrigerant R2 is discharged through the fourth port 1140 provided at the lower portion of the main body 1100 together with the surplus refrigerant SR and transferred to the chiller 8000 along the third refrigerant line 500 and the fourth refrigerant line 600. Then, the separated liquid refrigerant R2 is transferred to the compressor 2000 through the chiller 8000.

Additionally, some of the liquid refrigerant R2 and the surplus refrigerant SR is discharged through the first port 1110 and transferred to the outdoor unit 6000 along the first refrigerant line 300. Then, some of the liquid refrigerant R2 and the surplus refrigerant SR is transferred to the compressor 2000 along the second bypass line 800 via the outdoor unit 6000. In this way, in the heating mode, the first port 1110 may be used as an outlet for the liquid refrigerant R2.

In the heating mode, since the amount of circulating refrigerant R is relatively smaller than in the cooling mode, the level of the surplus refrigerant SR stored inside the main body 1100 is maintained in a high state.

The separation unit 1200 is disposed so that the flat plate part 1210 is positioned to be higher than the second port 1120 and the level of the surplus refrigerant SR, thereby preventing the refrigerant R introduced into the main body through the second port 1120 from being introduced into the third port 1130 located at the upper portion of the main body 1100.

Each of the gaseous refrigerant R1 and the liquid refrigerant R2 discharged from the main body 1100 is transferred to the compressor 2000 and then reintroduced into the second port 1120 through the first refrigerant line 300 and the first bypass line 700 to be circulated.

As described above, the gas-liquid separator 1000 according to the embodiment of the present invention is configured to separate the refrigerant R into a gas phase and a liquid phase before the refrigerant R circulates through the refrigerant line and is introduced into the compressor 2000, and at the same time to store the surplus refrigerant SR therein, thereby performing the same role as an accumulator disposed on the inlet side of a compressor in a conventional system. Thus, according to the present embodiment, the accumulator is omitted, the configuration of the entire system is simplified, and the number of component parts is reduced, which results in a cost reduction effect.

In addition, when the cooling/heating vapor injection function is implemented using a single gas-liquid separator 1000, the flow path of the refrigerant line may be simplified throughout the entire system, and the cooling/heating performance can be improved by reliably preventing the liquid refrigerant R2 from being introduced into the third port 1130 through the separation unit 1200 provided inside the main body 1100 of the gas-liquid separator 1000.

Although the present invention has been described above with reference to embodiments thereof, it will be understood by those skilled in the art that various modifications and changes may be made to the present invention without departing from the gist and scope of the present invention as set forth in the claims below. Additionally, the differences related to the modifications and changes should be construed as being included in the scope of the present invention defined in the appended claims.

1. A heating and cooling vapor injection system comprising:
a compressor configured to compress and circulate a refrigerant;
a first refrigerant line through which the compressed refrigerant moves and on which a first expansion valve, a condenser, and an outdoor unit are installed;
a gas-liquid separator into which the refrigerant passing through the first refrigerant line is introduced and which separates the refrigerant into a gaseous refrigerant and a liquid refrigerant;
a second refrigerant line through which the gaseous refrigerant discharged from the gas-liquid separator moves; and
a third refrigerant line through which the liquid refrigerant discharged from the gas-liquid separator moves and on which a second expansion valve and an evaporator are installed,
wherein each of the second refrigerant line and the third refrigerant line branches off at the gas-liquid separator and is connected to the compressor.

2. The heating and cooling vapor injection system of claim 1, further comprising:
a fourth refrigerant line connected to the third refrigerant line in parallel to move the liquid refrigerant to the compressor and on which a third expansion valve and a chiller are installed;
a first bypass line which branches off at the first expansion valve and is connected to the gas-liquid separator and through which the refrigerant moves; and
a second bypass line of which one end is connected to the first refrigerant line and the other end is connected to the third refrigerant line between the condenser and the outdoor unit and through which the refrigerant moves.

3. The heating and cooling vapor injection system of claim 2, wherein, on the third refrigerant line, the second expansion valve is disposed on an inlet side of the evaporator, and a first branch part and a second branch part are provided on an inlet side of the second expansion valve and an outlet side of the evaporator, respectively, and are connected to the fourth refrigerant line, and
on the fourth refrigerant line, the first branch part is disposed on an inlet side of the third expansion valve, and the second branch part is disposed on an outlet side of the chiller.

4. The heating and cooling vapor injection system of claim 3, wherein, on the first refrigerant line, a third branch part is provided on an outlet side of the condenser, and the second bypass line is connected to each of the third branch part and the second branch part.

5. The heating and cooling vapor injection system of claim 1, further comprising an indoor unit disposed between the compressor and the first expansion valve on the first refrigerant line,
wherein the indoor unit is installed inside an air conditioning case together with the evaporator.

6. The heating and cooling vapor injection system of claim 1, further comprising a fourth expansion valve disposed between the outdoor unit and the gas-liquid separator on the first refrigerant line,
wherein the gas-liquid separator constitutes a vapor injection module together with the fourth expansion valve.

7. The heating and cooling vapor injection system of claim 2, wherein the gas-liquid separator includes a first port connected to the first refrigerant line, a second port connected to the first bypass line, a third port connected to the second refrigerant line, and a fourth port connected to the third refrigerant line, and
according to air conditioning modes, the first port is configured to selectively operate as an inlet through which the refrigerant is introduced or an outlet through which the refrigerant is discharged, the second port is configured to operate as an inlet through which the refrigerant is introduced, and the third port and the fourth port are configured to operate as outlets through which the refrigerant is discharged.

8. The heating and cooling vapor injection system of claim 2, wherein the outdoor unit is formed so that an inlet and an outlet through which the refrigerant passes and moves are interchanged according to air conditioning modes.

9. The heating and cooling vapor injection system of claim 2, wherein the refrigerant discharged from the compressor moves to the first refrigerant line or the first bypass line through opening or closing of the first expansion valve according to air conditioning modes.

10-12. (canceled)

13. A gas-liquid separator comprising:
a main body configured to accommodate a surplus liquid refrigerant therein; and
a separation unit provided inside the main body,
wherein the main body has a first port and a second port, through which a refrigerant in a two-phase state passes, in one side surface and the other side surface thereof, respectively, and a third port and a fourth port through which a gaseous refrigerant and a liquid refrigerant separated from the refrigerant in the two-phase state are discharged separately, in upper and lower surfaces thereof, respectively, and
the separation unit prevents the liquid refrigerant from being introduced into the third port.

14. The gas-liquid separator of claim 13, wherein the separation unit is configured to move along the main body in an up-down direction.

15. The gas-liquid separator for a vehicle thermal management system of claim 13, wherein the separation unit includes a flat plate part that is horizontally disposed and has a shape corresponding to a cross-sectional shape of the main body, and a guide part that extends downward from the flat plate part.

16. The gas-liquid separator for a vehicle thermal management system of claim 15, wherein the flat plate part is positioned above a level of the surplus refrigerant.

17. The gas-liquid separator for a vehicle thermal management system of claim 15, wherein the separation unit further includes a control part connected to the guide part to control a position of the flat plate part.

18. The gas-liquid separator for a vehicle thermal management system of claim 17, wherein the control unit includes a power generator disposed outside the main body to generate a driving force to move the guide part in an up-down direction, or a buoyancy generator disposed inside the main body to generate a buoyancy to position an upper end of the guide part above the surplus refrigerant.

19. The gas-liquid separator for a vehicle thermal management system of claim 13, wherein, based on a lower surface of the main body, the second port is located to be higher than the first port is located, and the first port is located at least at a level higher than or equal to a level of the surplus refrigerant.

20. The gas-liquid separator for a vehicle thermal management system of claim 13, further comprising a stopper provided inside of the main body and extending downward from an inner side of the upper surface,
wherein the stopper is configured to limit upward movement of the separation unit to prevent the third port from being blocked by the separation unit.

21. The gas-liquid separator for a vehicle thermal management system of claim 20, wherein the stopper is provided with a mesh structure and disposed to be connected to the third port inside the main body.

22. The gas-liquid separator for a vehicle thermal management system of claim 13, wherein, in a cooling mode, the first port is opened and the second port is blocked so that the refrigerant in the two-phase state is introduced into the main body through the first port, the separated liquid refrigerant is discharged through the fourth port with the surplus refrigerant, and the separated gaseous refrigerant is discharged through the third port.

23. The gas-liquid separator for a vehicle thermal management system of claim 13, wherein, in a heating mode, the first port and the second port are opened so that the refrigerant in the two phase state is introduced into the main body through the second port, some of the separated liquid refrigerant is discharged through the fourth port together with the surplus refrigerant, the remaining liquid refrigerant is discharged through the first port with the surplus refrigerant, and the separated gaseous refrigerant is discharged through the third port.
